(19) United States
(12) Patent Application Publication
(10) Pub. No.: US 2025/0322091 A1
(43) Pub. Date: Oct. 16, 2025

(54) PURPOSE LIMIT ROOM FOR LIMITING PURPOSE OF DATA USAGE

(71) Applicants: Lemon Inc., Grand Caymon (KY); Beijing Zitiao Network Technology Co., Ltd., Beijing (CN)

(72) Inventors: Dayeol Lee, Culver City, CA (US); Mingshen Sun, Culver City, CA (US); Jianlin Jiang, Hangzhou (CN); Qiang Yan, Shanghai (CN)

(21) Appl. No.: 18/667,494

(22) Filed: May 17, 2024

Related U.S. Application Data
(63) Continuation of application No. PCT/CN2024/087344, filed on Apr. 11, 2024.

(51) Int. Cl. G06F 21/62; H04L 9/08; H04L 9/32

(52) U.S. Cl. CPC G06F 21/6218; H04L 9/0825; H04L 9/3213; H04L 9/3247; G06F 2221/2141

(57) ABSTRACT

This specification describes technologies for limiting usage of protected data to specified purposes. One method incudes loading a workload image encoding snapshot of a software application into a virtual environment for execution; providing a unique identifier of the workload image to a database system storing registered unique identifiers of workload images that have been sanitized; obtaining, from the database system, a purpose token signed by the purpose key associated with the purpose label; requesting a set of protected data from a data repository using the purpose token, wherein the purpose token is used to verify that the corresponding workload image with the matching registered unique identifier is permitted to access the set of protected data tagged with the one or more purpose labels; receiving, from the data repository, the set of protected data accessible by the software application when the executable snapshot is executed in the virtual environment.

### CLAIM OF PRIORITY

This application claims priority under 35 USC § 120 to the Patent Cooperation Treaty Application Serial No. PCT/CN2024/087344 filed on Apr. 11, 2024, the entire contents of which are hereby incorporated by reference.

### TECHNICAL FIELD

This specification generally relates to data access control on large-scale digital platforms so that usage of protected data is limited to the intended purpose of the underlying data. Protected data may refer to any data, such as user data, subject to one or more protection rules to safeguard, e.g., data privacy.

### BACKGROUND

Data privacy concerns on modern digital platforms are increasingly pronounced, especially with the popularity of artificial intelligence (AI) and machine learning tools that drive the proliferation of data through data-intensive operations such as data mining. Governments around the world have recognized the significance of protecting data privacy and have enacted various regulations to address this concern.

### SUMMARY

In one aspect, some implementations include a method comprising: loading a workload image into a virtual environment, the workload image encoding an executable snapshot of a software application for execution in the virtual environment; providing a unique identifier of the workload image to a database system storing registered unique identifiers of respective workload images that have been determined as secure; obtaining, from the database system, a purpose token comprising a purpose label for a corresponding workload image whose registered unique identifier matches the unique identifier; requesting a set of protected data from a data repository using the purpose token to verify that the corresponding workload image is permitted to access the set of protected data, the data repository storing sets of protected data each tagged with one or more purpose labels; and receiving, from the data repository, the set of protected data accessible by the software application when the executable snapshot is executed in the virtual environment.

The implementations may include one or more of the following features.

The purpose token may include: a message portion that includes the purpose label, and a digital signature portion that encodes the message portion as signed by a private key of a purpose key pair that corresponds to the purpose label. The purpose token may be verified based on, at least in part, by applying, to the digital signature portion of the purpose token, a public key of a purpose key pair that corresponds to one of the one or more purpose labels tagging the set of protected data. The virtual environment may be powered by one or more hardware processors, and wherein, when the executable snapshot is executed by the one or more hardware processors, the software application runs in a secure region on the one or more hardware processors where plain text access to the set of protected data is available. The set of protected data is encrypted using a public key of an owner of the workload image for decryption in the secure region on the one or more hardware processors where the software application runs. The set of protected data may be discarded after the software application has used the set of protected data. When the executable snapshot is executed to generate an output that is encrypted using a private key of an owner of the workload image so that, outside the secure region, contents of the output may be accessible only to the owner of the workload image. The executable snapshot may be executable for a limited number of times, or within a limited time window. The workload image may include one of: a container-based image, a process-based image, or a virtual-machine-based image. The workload image may be sanitized to identify known vulnerabilities and covert channels.

In another aspect, implementations include one or more computer-readable storage media encoded with instructions that, when executed by one or more computers, cause the one or more computers to perform operations of: loading a workload image into a virtual environment, the workload image encoding an executable snapshot of a software application for execution in the virtual environment; providing a unique identifier of the workload image to a database system storing registered unique identifiers of respective workload images that have been screened as free from known security risks; obtaining, from the database system, a purpose token comprising a purpose label for a corresponding workload image whose registered unique identifier matches the unique identifier; requesting a set of protected data from a data repository using the purpose token to verify that the corresponding workload image is permitted to access the set of protected data, the data repository storing sets of protected data each tagged with one or more purpose labels; and receiving, from the data repository, the set of protected data accessible by the software application when the executable snapshot is executed in the virtual environment.

The implementations may include one or more of the following features.

The purpose token may include: a message portion that includes the purpose label, and a digital signature portion that encodes the message portion as signed by a private key of a purpose key pair that corresponds to the purpose label. The purpose token may be verified based on, at least in part, by applying, to the digital signature portion of the purpose token, a public key of a purpose key pair that corresponds to one of the one or more purpose labels tagging the set of protected data. The virtual environment may be powered by one or more hardware processors included in the one or more computers. When the executable snapshot is executed by the one or more hardware processors, the software application may run in a secure region on the one or more hardware processors where plain text access to the set of protected data is available. The set of protected data may be encrypted using a public key of an owner of the workload image for decryption in the secure region on the one or more hardware processors where the software application runs. The set of protected data is discarded after the software application has used the set of protected data. When the executable snapshot is executed to generate an output that is encrypted using a private key of an owner of the workload image so that, outside the secure region, contents of the output may be accessible only to the owner of the workload image. The executable snapshot may be executable for a limited number of times, or within a limited time window. The workload image may include one of: a container-based image, a process-based image, or a virtual-machine-based image. The workload image may be sanitized to identify known vulnerabilities and covert channels. The unique identifier may be a hash. The virtual environment may include: a purpose limit room where the workload image is loaded onto a virtual machine, or one or more hardware processors. The database system may include: a workload library comprising registered hashes each associated with at least one purpose label; and a purpose key table comprising a plurality of purpose key pairs each associated with a corresponding purpose label.

In yet another aspect, the implementations may include a computer system comprising one or more computer processors configured to perform operations of: loading a workload image into a virtual environment, the workload image encoding an executable snapshot of a software application for execution in the virtual environment; providing a unique identifier of the workload image to a database system storing registered unique identifiers of respective workload images that have been screened as free from known security risks; obtaining, from the database system, a purpose token comprising a purpose label for a corresponding workload image whose registered unique identifier matches the unique identifier; requesting a set of protected data from a data repository using the purpose token to verify that the corresponding workload image is permitted to access the set of protected data, the data repository storing sets of protected data each tagged with one or more purpose labels; and receiving, from the data repository, the set of protected data accessible by the software application when the executable snapshot is executed in the virtual environment.

Implementations may include one or more of the following features.

The purpose token may include: a message portion that includes the purpose label, and a digital signature portion that encodes the message portion as signed by a private key of a purpose key pair that corresponds to the purpose label. The purpose token may be verified based on, at least in part, by applying, to the digital signature portion of the purpose token, a public key of a purpose key pair that corresponds to one of the one or more purpose labels tagging the set of protected data. The virtual environment may be powered by one or more hardware processors included in the one or more computers. When the executable snapshot is executed by the one or more hardware processors, the software application may run in a secure region on the one or more hardware processors where plain text access to the set of protected data is available. The set of protected data may be encrypted using a public key of an owner of the workload image for decryption in the secure region on the one or more hardware processors where the software application runs. The set of protected data is discarded after the software application has used the set of protected data. When the executable snapshot is executed to generate an output that is encrypted using a private key of an owner of the workload image so that, outside the secure region, contents of the output may be accessible only to the owner of the workload image. The executable snapshot may be executable for a limited number of times, or within a limited time window. The workload image may include one of: a container-based image, a process-based image, or a virtual-machine-based image. The workload image may be sanitized to identify known vulnerabilities and covert channels. The unique identifier may be a hash. The virtual environment may include: a purpose limit room where the workload image is loaded onto a virtual machine, or one or more hardware processors. The database system may include: a workload library comprising registered hashes each associated with at least one purpose label; and a purpose key table comprising a plurality of purpose key pairs each associated with a corresponding purpose label.

Implementations of the technologies described in the present specification may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The subject matter described in this specification can be implemented in particular embodiments so as to realize one or more of the following advantages. Implementations of the present disclosure address the technical challenges of protecting data privacy uniquely present on the back end of a digital platform by using a systematic approach to implement data purpose limitations to control what workload image (i.e., snapshots of software application) can access which data and for what purpose. The technology may include the following salient features as part of a solution to the technical challenges.

First, some implementations incorporate the use of a public key cryptography (PKC) signature on a purpose token to obtain protected data tagged with a purpose label where the purpose token includes a digital signature characteristic of a specific purpose label. For example, the digital signature can be a specific purpose label signed by a private key of a public-private key pair that is associated with the purpose label. When the digital signature is verified using a public key of the key pair associated with the purpose label, the verification can reveal the associated purpose label, which, if matched to a tagged purpose of the data set, can prompt the data repository of the data set to provide a copy of the data set. Thus, fine grained access control of protected data in accordance with the tagged purpose labels can be provided. Because the purpose label can be changed (e.g., added, modified, or deleted) by the data repository, access control can take effect once the tagged purpose label has been updated at the data repository. That alone is a major improvement of access control.

Second, some implementations provide automatic upkeep of a database storing registered hashes of workload images that have been vetted (e.g., demonstrated to be without software vulnerabilities and covert channels prone to data leakage). Access to protected data is thus reserved to workload images that have been verified as free from known security risks such as data leakage. Significantly, the storage overhead of registered hashes (as an example of unique identifiers) is less significant and much reduced than storing the full version of the workload images.

Third, some implementations may employ special purpose hardware processors with secure regions where plain access to protected data is limited to the workload image. In these implementations, data confidentiality and integrity can be maintained even if the computing resources are remoted and managed by third parties.

The details of one or more implementations of the subject matter of this specification are set forth in the description, the claims, and the accompanying drawings. Other features, aspects, and advantages of the subject matter will become apparent from the description, the claims, and the accompanying drawings.

### DESCRIPTION OF DRAWINGS

FIG. 1 illustrates an example of a workflow diagram for controlling operator access to protected data based on purpose limitation of the protected data.

FIG. 2 illustrates an example of a hardware processor with a secure region for implementing controlled access based on purpose limitation of the protected data.

FIG. 3 illustrates a flow chart of an example process on a server computer to implement controlled access based on purpose limitation of the protected data.

FIG. 4 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The technology described in this specification is directed to protecting privacy of data on digital platforms where the underlying data is not only voluminous, but also ever changing (e.g., the manner in which the data can be accessed on a content sharing platform). The increasing popularity of artificial intelligence (AI) and machine learning (ML) tools that leverage the available data for data mining has exacerbated the technical challenge of protecting privacy of protected data. By way of illustration, when restricting the usage of certain data for specific purposes, the allowed purposes are often set when the data is collected. When user consent is revoked, whether by the corresponding user or by law, the system can no longer use the data for the previously consented to purpose. On a digital platform using a cloud storage infrastructure, revoking access and changing policy on individual data can be slow, and the changes may not take effect immediately consistent with the user's wish.

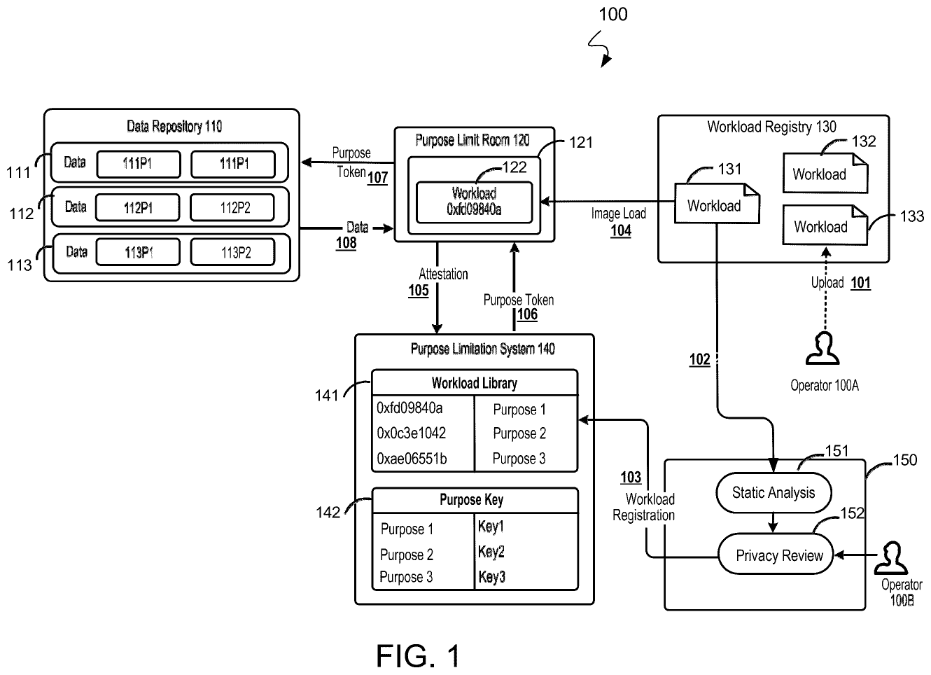

Moreover, enforcing that the data is used in accordance with the specific purposes can be difficult when, for example, programmers, data scientists, or data analysts on the backend of the digital platform can store and use the data for different purposes, either intentionally or unintentionally. More details of these features are provided below with references to FIGS. 1 through 4.

FIG. 1 illustrates an example of a workflow diagram 100 for controlling operator access to protected data based on purpose limitation of the protected data. At block 101, Operator 100A may upload a workload image to workload registry 130. Operator 100A can be an employee at the backend of an online platform providing service to a vast number of online users, for example, a content sharing platform, a social media platform, an e-commerce platform. Examples of operator 100A can include a programmer or a data scientist who may analyze protected data on the platform, or test beta-versions of software on existing protected data during software development.

Workload registry 130 is a holding place for workload images (e.g., workload images 131, 132, and 133). A workload image has the byte codes that encode snapshots of a software application. For example, the workload image has the executable codes for the software, including code dependencies and entry points, but significantly, without data for the executable codes to operate on. Examples of workload image can include: a virtual machine image, a container image, or a process image. Here, code dependencies can refer to the relationships between different pieces of code or software components where one component relies on another to function properly. Such dependencies can be in the form of libraries, modules, frameworks, or external services that a particular piece of code needs to perform its intended tasks. An entry point can refer to the location in the program for the software application where the execution of the program begins. In other words, the entry point can be the starting point from which the runtime environment initiates the execution of the software application by, e.g., setting up the program's environment, initializing variables, or performing other house-keeping tasks before the software application is fully launched.

At step 102, each workload image in workload registry 130 may be subject to code review (150) that includes static analysis (151) and privacy review (152). In some implementations, the code review can be conducted by third-parties other than the operating entity of the digital platform. For example, operator 100B may regularly review and analyze each workload image being submitted for review to detect, for example, a vulnerability or indication of malware. Examples of operator 100B may include a third-party reviewer, or an independent software analyst. This review and analysis process may also be known as a screening process, or a sanitization process. In some implementations, one or more workload image is sanitized regularly to identify known vulnerabilities and covert channels. In particular, one or more workload image is reviewed to verify that input data for processing by the software application is discarded after processing and no portion of the input data is transferred or stored that may result in data leakage. For example, taint analysis may be performed to trace the propagation of the input data through the software application's execution to determine how the input data is being processed and whether there are potential security vulnerabilities for data leakage. The code dependencies of each provided workload image may also be reviewed to determine whether a library or module in the chain of dependency has known vulnerability. The process can vet each registered workload image as free from known security risks such as data leakage. The registered work load images are also known as secure, i.e., without known risks of leaking data (e.g., data exploit).

For example, when no issues have been identified during code review (150), the workload image can be registered (103). In some cases, the registration takes place at purpose limitation system 140 where each registered workload image is associated with a purpose in workload library 141. As illustrated in FIG. 1, each entry in the workload library can be represented by a hash of the workload image and the associated purpose, which can be a descriptive purpose label such as marketing, fraud detection, or recommendation. In some implementations, the purpose limitation system 140 can incorporate a database system that also includes a table 142 of purpose keys. For example, table 142 may include, in each entry, a purpose label (e.g., a descriptive purpose label) and a key associated with the purpose label. In some implementations, each key can be a key pair that includes a private key and a public key. The purpose keys can be used (e.g., by the purpose limitation system 140) to issue purpose tokens, as described below.

When a workload is scheduled for a run (e.g., being executed by operator 100A), the workload image is uploaded from the workload registry 130 to purpose limit room 120 via image upload step 104. For example, the uploaded workload image can be kept in secure environment 121 where code can be executed to process protected data so that the outside has no visibility to the data being processed. In some implementations, purpose limit room 120 is part of a virtual environment where the executable byte codes of the workload image are executed. In some implementations, the virtual environment also encompasses the purpose limitation system 140. In some cases, the virtual environment can be powered by a virtual machine, or a special purpose hardware processor. For example, the special purpose hardware processor can include a trusted execution environment processor which can create the secure enclave in which code can be executed to process protected data in isolation from the rest of the processor and the host computer. The virtual machine can provide similar granularity of data protection at run time.

Significantly, the purpose limit room 120 performs attestation (105). For example, a hash of the workload image may be computed and then compared with the registered hash of the workload, as stored on the purpose limitation system 140, e.g., at the workload library 141. When the hash of the workload image to be run matches the hash of the registered workload image, the purpose limit room 120 may obtain a purpose token from the purpose limitation system 140. The purpose token may be generated by the purpose limitation system 140 to include a message and a digital signature. The message can include the purpose label (e.g., a descriptive label) for the workload image. The digital signature is the message signed, for example, using a private key of the corresponding purpose key pair for the purpose label. The purpose token may be released by the purpose limitation system 140 so that the purpose limit room 120 receives the purpose token for the workload image being loaded for execution (106).

The purpose limit room 120 may transmit, to data repository 110, the purpose token to request a set of protected data for the uploaded workload image to access (107). Data repository 110 can be a data vault provided by a cloud service where sets of protected data are stored, including, for example, data sets 111, 112, and 113. Each data set can include a data field, a data record, or multiple data record. The cloud service may be hosted by a third-party where data storage is housed in one or more designated geological location. Each set of protected data is tagged with one or more purpose labels. The purpose labels may be obtained from user when, for example, receiving user consents to various forms of data usage. For example, data set 111 may be tagged with purpose labels 111P1 and 111P2; data set 112 may be tagged with purpose labels 112P1 and 112P2; and data set 113 may be tagged with purpose labels 113P1 and 113P2. Data retention and repurposing are managed by data repository 110.

Upon receiving the purpose token from purpose limitation room 120, data repository 110 may verify the purpose token by, for example, decrypting the signature portion of the purpose token using a public key of the purpose key pair associated with the purpose label. Responsive to the decrypted signature matching the purpose label in the message portion of the purpose token, data repository 110 may proceed to release to data set with the tagged purpose label. The data repository 110 transmits the data set to purpose limit room 120 so that the uploaded workload image can be executed in secure enclave 122 to process the data set (108). In the event that the decrypted signature does not match the purpose label in the message portion of the purpose token, or the message label does not match one of the tagged purpose labels of the requested data set, data repository 110 may refuse to send the data set to purpose limit room 120. For example, data repository 110 may ignore the request from purpose limit room 120 for the data set and without returning an indication that the request has been discarded.

When the purpose limit room 120 receives the data set, the workload image is executed in secure environment 121 to process the data set. The purpose room 120 can decrypt the protected data for the secure environment 121. Once the data set is inside the secure environment, only the workload image can access the plain text of the data set. Outside the secure environment, the data set remains encrypted in the purpose limit room. In some implementations, the workload image can be executed for a limited number of times, which can be specified by the purpose token provided by purpose limitation system 140 to purpose limit room 120, or specified by the upload request from workload registry 130. Additionally, or alternatively, the workload image can be executed within a limited time frame (e.g., within a time window, or by an expiration date/time). For example, the purpose limit room 120 may incorporate a counter that tracks the number of times the executable snapshot is executed. The purpose limit room 120 may also incorporate a timer or clock for tracking time. Moreover, output generated by the software application when the workload image is executed is encrypted by, for example, a public key of the owner (or custodian) of the workload image so that the output can only be inspected by the owner. Thus, the infrastructure, as illustrated in this diagram, achieves fine-grained access control of protected data so that each workload image can only access and process protected data tagged with a purpose label that matches a specific purpose associated with the workload.

While diagram 100 shows limit purpose room 120 presenting purpose token to obtain access to protected data at data repository 110, the implementations are not so limited. In fact, some implementations may encrypt the data sets on data repository 110 with respective keys specific to the purpose labels of each data set. The decryption key for a data set encrypted for a corresponding purpose label can be released by the purpose limitation system 140, for example, after verifying the purpose of the workload in a manner similar to the description above.

The workload image described above can include a container-based workload, a process-based workload, or a virtual-machine-based workload. Containerization can involve packaging a software application and its dependencies into a container image. The container image can be self-sufficient by encapsulating code, runtime libraries and system tools into one image. A process-based workload image can involve packaging a running an application as one or more processes on a host machine. Each process runs independently and communicates with others through inter-process communication mechanisms and share the host machine's resources.

Virtualization involves creating virtual machines (VMs) that emulate a complete physical computer. Each VM runs a separate operating system instance and can host one or more applications. Depending on the composition of the workload image, the workload registry can contain container images (for container-based workload image), program binaries (for process-based workload image) or VM images (for virtual-machine-based workload image).

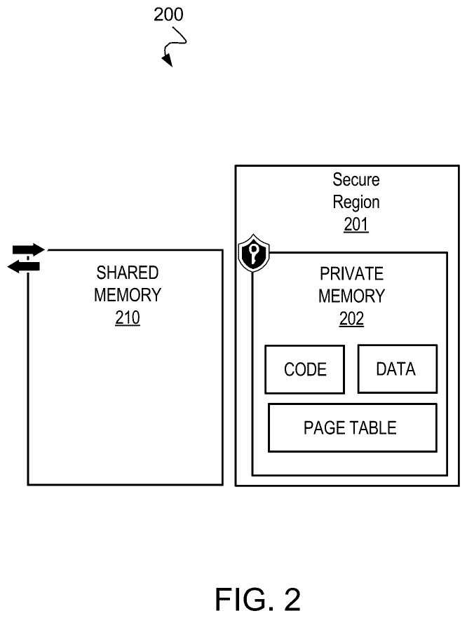

FIG. 2 illustrates an example of a special purpose hardware processor 200 that can power the virtual environment, for example, the purpose limit room of FIG. 1. The special purpose hardware processor includes secure region 201, which can also be referred to as a trusted region or trusted environment. Significantly, secure region 201 can be a dedicated area on hardware processor 200, which includes private memory 202. As illustrated, private memory 202 is a protected area for memory confidentiality and integrity. For example, private memory 202 can be protected and isolated from the rest of hardware processor 200 in that plain text access to data and page table is available inside private memory 202. In some implementations, protected data can be stored in private memory 202. When protected data arrives from data repository 110, protected data may be encrypted using a public key of the owner of the workload image. When the protected data is provided to secure region 201, only the owner of the workload image can read the contents of protected data inside private memory 202 by virtue of using the private key of the owner. For example, coworkers without the owner's private key may not be able to read the contents of protected data. On the other hand, shared memory 210 of the hardware processor provides access to data that can be shared.

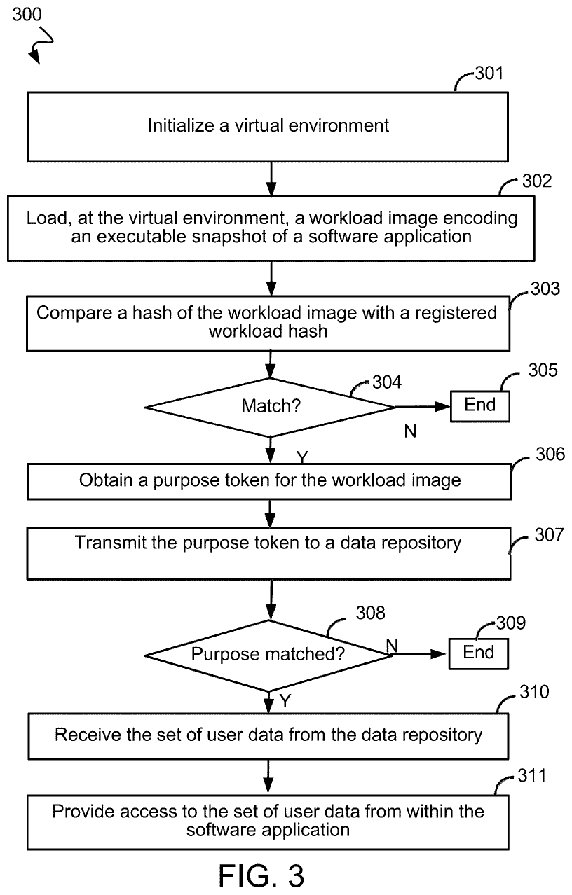

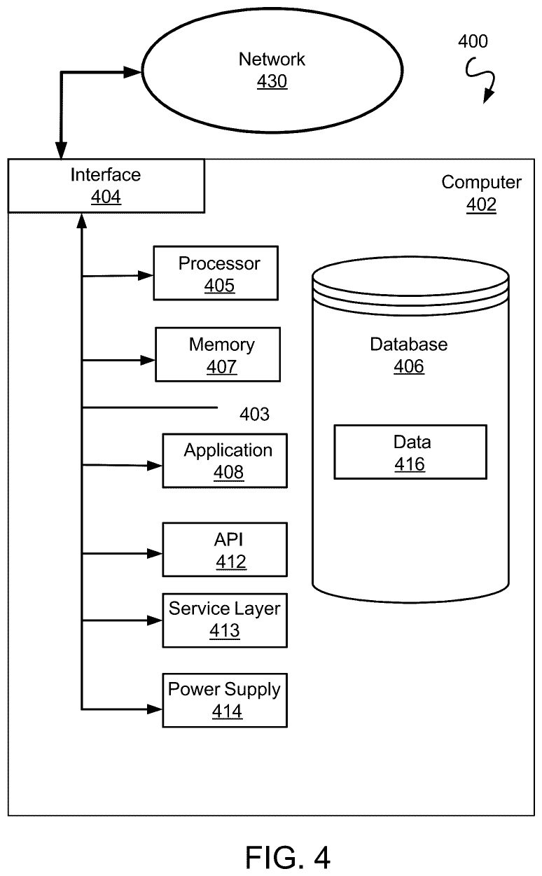

FIG. 3 illustrates a flowchart of an example process 300 for implementing controlled access based on purpose limitation of the protected data. For convenience, the process 300 will be described as being performed by a system of one or more computers, located in one or more locations, and programmed appropriately in accordance with this specification. For example, the system illustrated in diagram 100 can incorporate a server computer, such as the server computer 402 of FIG. 4, that when appropriately programmed, can perform the process 300.

In block 301, the system may initiate a virtual environment including, for example, a purpose limit room (e.g., purpose limit room 120 of FIG. 1). The virtual environment can also include purpose limitation system e.g., purpose limitation system 140 of FIG. 1. For example, the purpose limitation system may provide a purpose limitation database that includes a workload library holding registered hashes of pre-approved and screened workload images, and a purpose key table holding purpose keys associated with respective purpose labels. Each purpose key can be a private-public key pair. The virtual environment may be powered by a virtual machine that emulates a complete hardware physical computer in executing. e.g., a software application contained in a workload image. The virtual environment may also be powered by one or more hardware processors, for example, one or more special purpose hardware processors configured to create a secure enclave where protected data can be processed. An example of such a hardware processor is described above with reference to FIG. 2.

The system may load, at the virtual environment, a workload image encoding a snapshot of a software application (302). As explained above with reference to FIG. 1, the workload image can include one of: a container-based image, a process-based image, or a virtual machine-based image. The workload image may be initially submitted by an operator at a workload registry, e.g., workload registry 130 of FIG. 1. Significantly, the workload images are vetted by static analysis and privacy review to verify no existence of known vulnerabilities in code dependencies, or known covert channels when the software application runs. The implementations may only register the vetted workload images in the database on purpose limitation system where, for example, the hashes of the vetted workload images are registered, as described above.

Once the workload image is loaded at the virtual environment, the loading may cause the underlying virtual machine or the underlying hardware processor to request and obtain protected data so that the software application can access the protected data. In more detail, the virtual machine or the one or more hardware processor may compare a hash of the workload image with the registered hash for the vetted version of the workload image (303). Here, the hash of the workload image being loaded can be computed. The registered hash of the vetted version of the workload image is available in the database of purpose limit system, as explained above with reference to FIG. 1.

The virtual machine or the one or more hardware processor may determine the hash of the workload image matches the registered hash for the vetted version of the workload image (304). In case of no match, the workload image can be ignored and the process terminated (305).

In response to determining that the hash of the workload image matches the registered hash for the vetted version of the workload image, the virtual machine or the one or more hardware processor may obtain a purpose token for the workload image being loaded (306). As explained above with reference to FIG. 1, The purpose token may be generated by the purpose limitation system to include a message portion and a digital signature portion. The message portion can include the purpose label (e.g., a descriptive label) for the workload image. The message portion may also include a hash of the message portion, as well as an expiration time for the purpose token (e.g., valid until a specific time, or expiring in a given period of time). In some cases, the expiration time may include a counter that decrements each time the token is used to obtain access to data at the data repository. The digital signature is the message signed, for example, using a private key of the corresponding purpose key pair for the purpose label. The purpose token may be released by the purpose limitation system so that the purpose limit room receives the purpose token for the workload image being loaded for execution.

The virtual machine or the one or more hardware processor may transmit the purpose token to a data repository, e.g., data repository 110 (307). The purpose token may be used to obtain the requested protected data. For example, the signature portion of the purpose token may be decrypted to reveal the purpose label, which, if matches the purpose label of the message portion of the token as well as a tagged purpose of the requested protected data set, the requested protected data set can be transmitted from the data repository to the purpose limit room, as described above with reference to FIG. 1. In other words, in response to determining that the purpose label matches the purpose of the protected data (308), the virtual machine or the one or more hardware processor may receive the set of protected data from the data repository (310). Otherwise, the data repository may refuse to transmit the requested protected data set (309).

When the requested protected data set is received at the virtual machine, or the one or more hardware processors, access to the requested protected data set is provided to the software application in the workload image as the software application runs on the virtual machine, or the one or more hardware processors (311). In some implementations, the protected data set may be transmitted from the data repository to the purpose limit room in an encrypted state using a public key of the owner of the workload image so that only the software application can access the contents of the protected data set. In some implementations, as the software application operates on the protected data set and generates output, the output is encrypted with a private key of the owner of the workload image so that only the owner of the workload image can inspect and review the contents of the output. In the implementations, a secure channel is established, for example, using a secure transport layer, between the data repository and the purpose limit room so that data communication between the data repository and the purpose limit no room is encrypted with keys that updated according to protocols of the secure transport layer.

FIG. 4 is a block diagram illustrating an example of a computer system 400 used to provide computational functionalities associated with described algorithms, methods, functions, processes, flows, and procedures, according to an implementation of the present disclosure. The illustrated computer 402 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 402 can comprise a computer that includes an input device, such as a keypad, keyboard, touch screen, another input device, or a combination of input devices that can accept user information, and an output device that conveys information associated with the operation of the computer 402, including digital data, visual, audio, another type of information, or a combination of types of information, on a graphical-type user interface (UI) (or GUI) or other UI.

The computer 402 can serve in a role in a computer system as a client, network component, a server, a database or another persistency, another role, or a combination of roles for performing the subject matter described in the present disclosure. The illustrated computer 402 is communicably coupled with a network 430. In some implementations, one or more components of the computer 402 can be configured to operate within an environment, including cloud-computing-based, local, global, another environment, or a combination of environments.

The computer 402 is an electronic computing device operable to receive, transmit, process, store, or manage data and information associated with the described subject matter. According to some implementations, the computer 402 can also include or be communicably coupled with a server, including an application server, e-mail server, web server, caching server, streaming data server, another server, or a combination of servers.

The computer 402 can receive requests over network 430 (for example, from a client software application executing on another computer 402) and respond to the received requests by processing the received requests using a software application or a combination of software applications. In addition, requests can also be sent to the computer 402 from internal users, external or third-parties, or other entities, individuals, systems, or computers.

Each of the components of the computer 402 can communicate using a system bus 403. In some implementations, any or all of the components of the computer 402, including hardware, software, or a combination of hardware and software, can interface over the system bus 403 using an application programming interface (API) 412, a service layer 413, or a combination of the API 412 and service layer 413. The API 412 can include specifications for routines, data structures, and object classes. The API 412 can be either computer-language independent or dependent and refer to a complete interface, a single function, or even a set of APIs. The service layer 413 provides software services to the computer 402 or other components (whether illustrated or not) that are communicably coupled to the computer 402. The functionality of the computer 402 can be accessible for all service consumers using this service layer. Software services, such as those provided by the service layer 413, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 402, alternative implementations can illustrate the API 412 or the service layer 413 as stand-alone components in relation to other components of the computer 402 or other components (whether illustrated or not) that are communicably coupled to the computer 402. Moreover, any or all parts of the API 412 or the service layer 413 can be implemented as a child or a sub-module of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402. The interface 404 is used by the computer 402 for communicating with another computing system (whether illustrated or not) that is communicatively linked to the network 430 in a distributed environment. Generally, the interface 404 is operable to communicate with the network 430 and comprises logic encoded in software, hardware, or a combination of software and hardware. More specifically, the interface 404 can comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors can be used according to particular needs, desires, or particular implementations of the computer 402. Generally, the processor 405 executes instructions and manipulates data to perform the operations of the computer 402 and any algorithms, methods, functions, processes, flows, and procedures as described in the present disclosure.

The computer 402 also includes a database 406 that can hold data for the computer 402, another component communicatively linked to the network 430 (whether illustrated or not), or a combination of the computer 402 and another component. For example, database 406 can be an in-memory, conventional, or another type of database storing data consistent with the present disclosure. In some implementations, database 406 can be a combination of two or more different database types (for example, a hybrid in-memory and conventional database) according to particular needs, desires, or particular implementations of the computer 402 and the described functionality. Although illustrated as a single database 406 in FIG. 4, two or more databases of similar or differing types can be used according to particular needs, desires, or particular implementations of the computer 402 and the described functionality. While database 406 is illustrated as an integral component of the computer 402, in alternative implementations, database 406 can be external to the computer 402. As illustrated, the database 406 holds the previously described data 416 including, for example, records protected data stored at data repository 110.

The computer 402 also includes a memory 407 that can hold data for the computer 402, another component or components communicatively linked to the network 430 (whether illustrated or not), or a combination of the computer 402 and another component. Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 or similar or differing types can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in the present disclosure. For example, application 408 can serve as one or more components, modules, or applications. Further, although illustrated as a single application 408, the application 408 can be implemented as multiple applications 408 on the computer 402. In addition, although illustrated as integral to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion or management circuits (including recharging, standby, or another power management functionality). In some implementations, the power-supply 414 can include a power plug to allow the computer 402 to be plugged into a wall socket or another power source to, for example, power the computer 402 or recharge a rechargeable battery.

There can be any number of computers 402 associated with, or external to, a computer system containing computer 402, each computer 402 communicating over network 430. Further, the term “client,” “user,” or other appropriate terminology can be used interchangeably, as appropriate, without departing from the scope of the present disclosure. Moreover, the present disclosure contemplates that many users can use one computer 402, or that one user can use multiple computers 402.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
loading a workload image into a virtual environment, the workload image encoding an executable snapshot of a software application for execution in the virtual environment;
providing a unique identifier of the workload image to a database system storing registered unique identifiers of respective workload images that have been determined as secure;
obtaining, from the database system, a purpose token comprising a purpose label for a corresponding workload image whose registered unique identifier matches the unique identifier;
requesting a set of protected data from a data repository using the purpose token to verify that the corresponding workload image is permitted to access the set of protected data, the data repository storing sets of protected data each tagged with one or more purpose labels; and
receiving, from the data repository, the set of protected data accessible by the software application when the executable snapshot is executed in the virtual environment.

2. The computer-implemented method of claim 1, wherein the purpose token comprises: a message portion that includes the purpose label, and
a digital signature portion that encodes the message portion as signed by a private key of a purpose key pair that corresponds to the purpose label.

3. The computer-implemented method of claim 2, wherein the purpose token is verified based on, at least in part, by applying, to the digital signature portion of the purpose token, a public key of a purpose key pair that corresponds to one of the one or more purpose labels tagging the set of protected data.

4. The computer-implemented method of claim 1, wherein the virtual environment is powered by one or more hardware processors, and
wherein, when the executable snapshot is executed by the one or more hardware processors, the software application runs in a secure region on the one or more hardware processors where plain text access to the set of protected data is available.

5. The computer-implemented method of claim 4, wherein the set of protected data is encrypted using a public key of an owner of the workload image for decryption in the secure region on the one or more hardware processors where the software application runs, and
wherein the set of protected data is discarded after the software application has used the set of protected data.

6. The computer-implemented method of claim 4, wherein, when the executable snapshot is executed to generate an output that is encrypted using a private key of an owner of the workload image so that, outside the secure region, contents of the output are accessible only to the owner of the workload image, and
wherein the executable snapshot is executable for a limited number of times, or within a limited time window.

7. The computer-implemented method of claim 1, wherein the workload image comprises one of: a container-based image, a process-based image, or a virtual-machine-based image, and
wherein the workload image is sanitized to identify known vulnerabilities and covert channels.

8. One or more computer-readable storage media encoded with instructions that, when executed by one or more computers, cause the one or more computers to perform operations of:
loading a workload image into a virtual environment, the workload image encoding an executable snapshot of a software application for execution in the virtual environment;
providing a unique identifier of the workload image to a database system storing registered unique identifiers of respective workload images that have been screened as free from known security risks;
obtaining, from the database system, a purpose token comprising a purpose label for a corresponding workload image whose registered unique identifier matches the unique identifier;
requesting a set of protected data from a data repository using the purpose token to verify that the corresponding workload image is permitted to access the set of protected data,
the data repository storing sets of protected data each tagged with one or more purpose labels; and
receiving, from the data repository, the set of protected data accessible by the software application when the executable snapshot is executed in the virtual environment.

9. The one or more computer-readable storage media of claim 8, wherein the purpose token comprises:
a message portion that includes the purpose label, and
a digital signature portion that encodes the message portion as signed by a private key of a purpose key pair that corresponds to the purpose label.

10. The one or more computer-readable storage media of claim 9, wherein the purpose token is verified based on, at least in part, by applying, to the digital signature portion of the purpose token, a public key of a purpose key pair that corresponds to one of the one or more purpose labels tagging the set of protected data.

11. The one or more computer-readable storage media of claim 8, wherein the virtual environment is powered by one or more hardware processors included in the one or more computers, and
wherein, when the executable snapshot is executed by the one or more hardware processors, the software application runs in a secure region on the one or more hardware processors where plain text access to the set of protected data is available.

12. The one or more computer-readable storage media of claim 11, wherein the set of protected data is encrypted using a public key of an owner of the workload image for decryption in the secure region on the one or more hardware processors where the software application runs, and
wherein the set of protected data is discarded after the software application has used the set of protected data.

13. The one or more computer-readable storage media of claim 11, wherein, when the executable snapshot is executed to generate an output that is encrypted using a private key of an owner of the workload image so that, outside the secure region, contents of the output are accessible only to the owner of the workload image, and
wherein the executable snapshot is executable for a limited number of times, or within a limited time window.

14. The one or more computer-readable storage media of claim 11, wherein the workload image comprises one of: a container-based image, a process-based image, or a virtual-machine-based image, and
wherein the workload image is sanitized to identify known vulnerabilities and covert channels.

15. The one or more computer-readable storage media of claim 11, wherein
the unique identifier is a hash, and
wherein the virtual environment comprises:
a purpose limit room where the workload image is loaded onto a virtual machine, or one or more hardware processors; and
the database system comprising:
a workload library comprising registered hashes each associated with at least one purpose label; and
a purpose key table comprising a plurality of purpose key pairs each associated with a corresponding purpose label.

16. A computer system comprising one or more computer processors configured to perform operations of:
loading a workload image into a virtual environment, the workload image encoding an executable snapshot of a software application for execution in the virtual environment;
providing a unique identifier of the workload image to a database system storing registered unique identifiers of respective workload images that have been screened as free from known security risks;
obtaining, from the database system, a purpose token comprising a purpose label for a corresponding workload image whose registered unique identifier matches the unique identifier;
requesting a set of protected data from a data repository using the purpose token to verify that the corresponding workload image is permitted to access the set of protected data, the data repository storing sets of protected data each tagged with one or more purpose labels; and
receiving, from the data repository, the set of protected data accessible by the software application when the executable snapshot is executed in the virtual environment.

17. The computer system of claim 16, wherein the purpose token comprises:
a message portion that includes the purpose label, and
a digital signature portion that encodes the message portion as signed by a private key of a purpose key pair that corresponds to the purpose label; and
wherein the purpose token is verified based on, at least in part, by applying, to the digital signature portion of the purpose token, a public key of a purpose key pair that corresponds to one of the one or more purpose labels tagging the set of protected data.

18. The computer system of claim 16, wherein the virtual environment is powered by one or more hardware processors included in the one or more computer processors,
wherein, when the executable snapshot is executed by the one or more hardware processors, the software application runs in a secure region on the one or more hardware processors where plain text access to the set of protected data is available,
wherein the set of protected data is encrypted using a public key of an owner of the workload image for decryption in the secure region on the one or more hardware processors where the software application runs,
wherein the set of protected data is discarded after the software application has used the set of protected data,
wherein, when the executable snapshot is executed to generate an output that is encrypted using a private key of an owner of the workload image so that, outside the secure region, contents of the output are accessible only to the owner of the workload image, and
wherein the executable snapshot is executable for a limited number of times, or within a limited time window.

19. The computer system of claim 16, wherein the workload image comprises one of:
a container-based image, a process-based image, or a virtual-machine-based image, and
wherein the workload image is sanitized to identify known vulnerabilities and covert channels.

20. The computer system of claim 16, wherein the unique identifier is a hash, and wherein the virtual environment comprises:
a purpose limit room where the workload image is loaded onto a virtual machine, or one or more hardware processors; and
the database system comprising:
a workload library comprising the registered hashes each associated with at least one purpose label; and
a purpose key table comprising a plurality of purpose key pairs each associated with a corresponding purpose label.
